(19) United States
(12) Patent Application Publication
(10) Pub. No.: US 2018/0040319 A1
(43) Pub. Date: Feb. 8, 2018

(54) Method for Implementing A Voice Controlled Notification System

(71) Applicant: LifeAssist Technologies Inc, San Francisco, CA (US)

(72) Inventor: Gary Rotman, Toronto (CA)

(21) Appl. No.: 15/721,348

(22) Filed: Sep. 29, 2017

Related U.S. Application Data
(63) Continuation-in-part of application No. 14/097,201, filed on Dec. 4, 2013, now abandoned.

(51) Int. Cl. G10L 15/22; G10L 15/06; G10L 15/30; G10L 15/08

(52) U.S. Cl. CPC G10L 15/22; G10L 15/08; G10L 15/063; G10L 15/30; G10L 2015/223; G10L 2015/088; G10L 2015/0635

(57) ABSTRACT

A method for implementing a voice controlled notification system uses a dedicated PC device that receives verbal commands and outputs reminders of upcoming tasks and events. Additionally, the method requires the use of a remote server that stores information about a user, and performs the background processes required to satisfy the user's verbal commands. The method continuously tracks the current date-and-time so that the user is presented with an appropriate reminder at the appropriate time. As a result, the user is kept abreast of upcoming tasks and events. The method for implementing a voice controlled notification system enables the user to interact with the PC device by issuing verbal commands. Accordingly, the method can interpret the user's speech and provide the user with information that is relevant to the issued verbal command.

The current application claims a priority to the U.S. Provisional patent application Ser. No. 14/097,201 filed on Dec. 4, 2013.

### FIELD OF THE INVENTION

The present invention relates generally to a voice controlled digital assistant. More particularly, the present invention relates to a method for implementing a life-management system that recognizes verbal commands, creates a schedule of personal notifications, and reminds a user to perform scheduled tasks at the appointed time.

### BACKGROUND OF THE INVENTION

Alarms clocks are known in the prior art, and include digital and analog devices. The clocks of the prior art utilize buttons or knobs to set the timing and alarm functions. A user must therefore look at the alarm clock, and manipulate the buttons or knobs and to set the alarm. When the prior art alarm clock is mounted on a wall or a high location, the user may need to climb a ladder or other structure to access the clock, creating a potential dangerous situation due to risk of fall. When the prior art alarm clock is a desktop type alarm clock, the user must press buttons to (1) stop the alarm and/or (2) activate a snooze feature. Alarm clocks are usually very limited in the number of alarms that may be set. Additionally, the available alarms are typically limited to a simple alarm sound and or a flashing light.

When the prior art alarm clock is a digital electronic device, the user must execute a complex sequence of steps, i.e., a series of button presses, just to set the time or set alarm times. For example, to set the time and date to “10:23 PM” and “December 6” in the prior art alarm clock, one typically presses a “Set Clock” button to enter a clock time setting mode. One must then press a “+” or “−” button to select AM or PM, and finally press a “SET CLOCK” button to confirm a setting. To change the clock hour one must, repeatedly presses or hold the “+” or “−” button until the hour digit “10” appears, then press the “Set Clock” button again to confirm the setting. Furthermore, to change the clock minute one must repeat the sequence to finish setting the clock minute to “23,” and again repeats a button-pressing sequence to set the calendar to “December 6.” Disabled or elderly persons with reduced cognitive ability can require reminders for activities of daily living to help live independently, i.e. health or personal or household related. Disabled persons often require uncomplicated solutions.

The method of the present invention addresses these difficulties by providing a reminder system which delivers personalized reminders or messages at a specific time. These reminders are delivered without any physical interaction between the user and the device. Additionally, the method of the present invention enables a user to make use of verbal commands to control an unobtrusive alarm clock. Furthermore, the method of the present invention can be used with various types of computing devices and is not limited to a single alarm clock system.

### BRIEF DESCRIPTION OF THE DRAWINGS

FIG. 1 is a block diagram illustrating the system overview of the present invention.

FIG. 2 is a flowchart describing the overall process followed by the method of the present invention.

FIG. 3 is a flowchart describing a sub-process where the local user adds a new personal reminder to a list of personal reminders using the method of the present invention.

FIG. 4 is a flowchart describing a sub-process where the remote user adds a new personal reminder to a list of personal reminders using the method of the present invention.

FIG. 5 is a flowchart describing a sub-process for relaying an acknowledgement notification to the remote user when the local user has received a personal reminder through the method of the present invention.

FIG. 6 is a flowchart describing a sub-process for relaying a no-response notification to the remote user when the local user does not acknowledge the receipt of a personal reminder through the method of the present invention.

FIG. 7 is a flowchart describing a sub-process for sending a notification to the local user when the environmental sensing devices identify a predefined condition in the environment around the local user using the method of the present invention.

FIG. 8 is a flowchart describing a sub-process for sending a notification to the remote user when the environmental sensing devices identify a predefined condition in the environment around the local user using the method of the present invention.

FIG. 9 is a flowchart describing a sub-process for searching the internet for a desired piece of information using the method of the present invention.

FIG. 10 is a flowchart describing a sub-process for setting an alarm using the method of the present invention.

FIG. 11 is a flowchart describing a sub-process for presenting the local user with a list of all personal notifications that are scheduled on a specific date using the method of the present invention.

FIG. 12 is a flowchart describing a sub-process for initiating the verbal command process by listening for a vocal trigger using the method of the present invention.

FIG. 13 is a flowchart describing a sub-process for updating the vocal trigger using the method of the present invention.

FIG. 14 is a flowchart describing a sub-process for presenting the local user with a list of all possible verbal commands using the method of the present invention.

FIG. 15 illustrates the symbols used in FIG. 16 through FIG. 33.

FIG. 16 is a flowchart for an exemplary “Main” audio command decoder.

FIG. 17 is a flowchart for an exemplary “Set Time” audio command recognition routine.

FIG. 18 is a flowchart for an exemplary “Set Date” audio command recognition routine.

FIG. 19 is a flowchart for an exemplary “Set Alarm Time” audio command recognition routine.

FIG. 20 is a flowchart for an exemplary “Choose Alarm Sound” audio command recognition routine.

FIG. 21 is a flowchart for an exemplary “Report” audio command recognition routine.

FIG. 22 is a flowchart for an exemplary “Report Help” audio command recognition routine.

FIG. 23 is a flowchart for an exemplary “Alarm” command processing routine.

FIG. 24 is a flowchart for an exemplary “Buttons and Switches” command processing routines.

FIG. 25 is a flowchart for an exemplary “Reminder Count” command processing Reminder Saving routine.

FIG. 26 is a flowchart for an exemplary “Record Reminders” command processing Reminder Recording routine.

FIG. 27 is a flowchart for an exemplary “Play All Reminders” command processing play all reminder recordings stored routine.

FIG. 28 is a flowchart for an exemplary “Manual Play Reminder” command processing manual playback reminder of stored recordings routine.

FIG. 29 is a flowchart for an exemplary “Reminder Time” command processing reminder time programming for a stored recording routine.

FIG. 30 is a flowchart for an exemplary “Different Day” command processing different day reminder time programming for a stored recording routine.

FIG. 31 is a flowchart for an exemplary “Reminder Flow” command processing reminder message playback time and acknowledgement command recognition programming for a stored recording routine.

FIG. 32 is a flowchart for an exemplary “Calendar Date” audio command processing reminder message playback time and date programming for a stored recording routine.

FIG. 33 is a flowchart for an exemplary “Play Today's Reminders” command processing play today's reminder recordings stored routine.

### DETAIL DESCRIPTIONS OF THE INVENTION

All illustrations of the drawings are for the purpose of describing selected versions of the present invention and are not intended to limit the scope of the present invention.

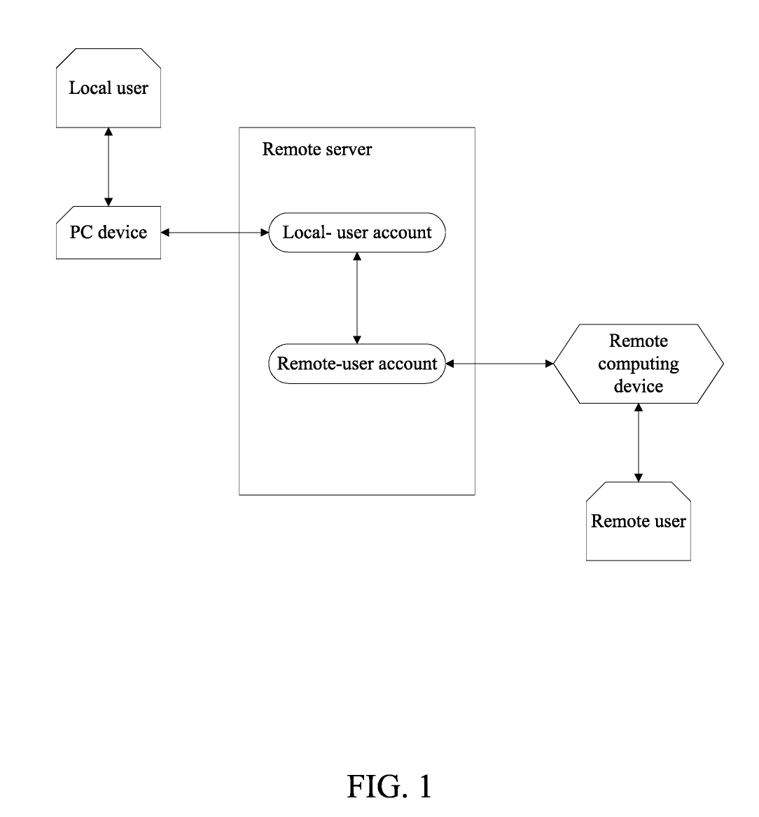

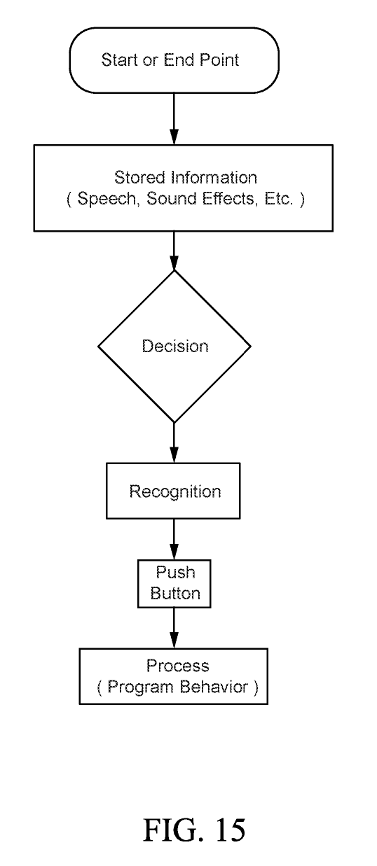

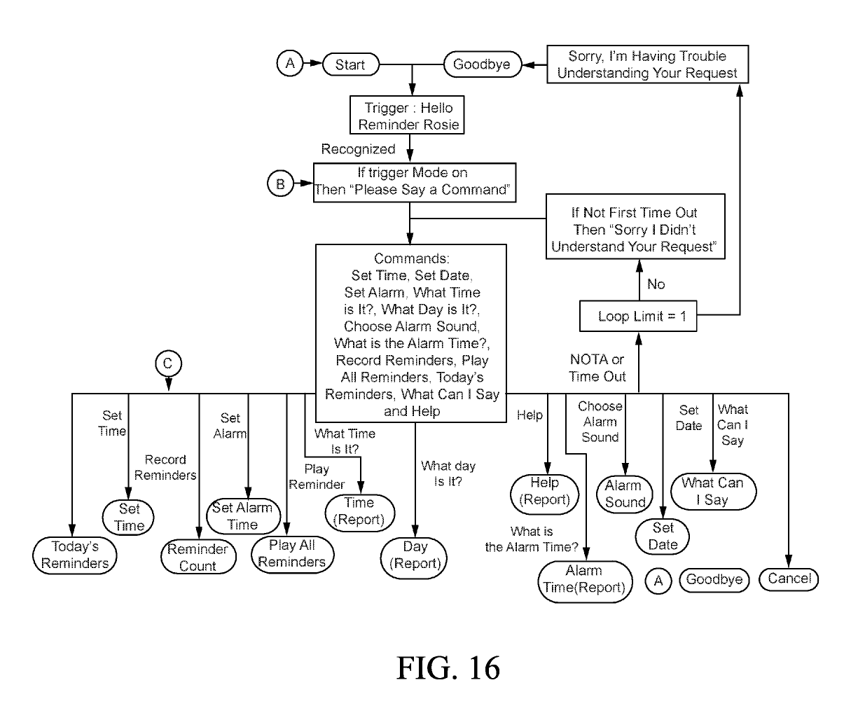

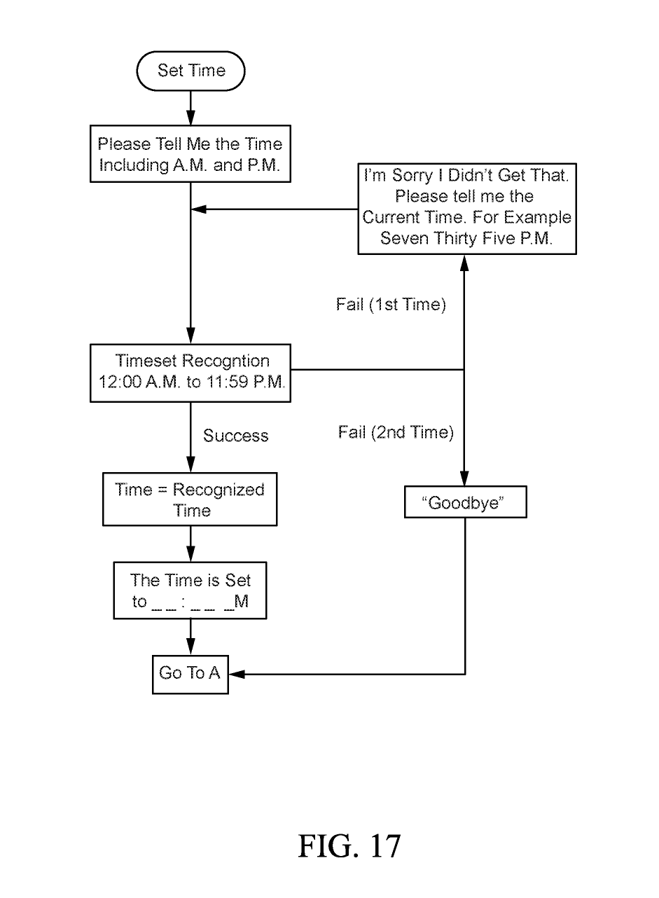

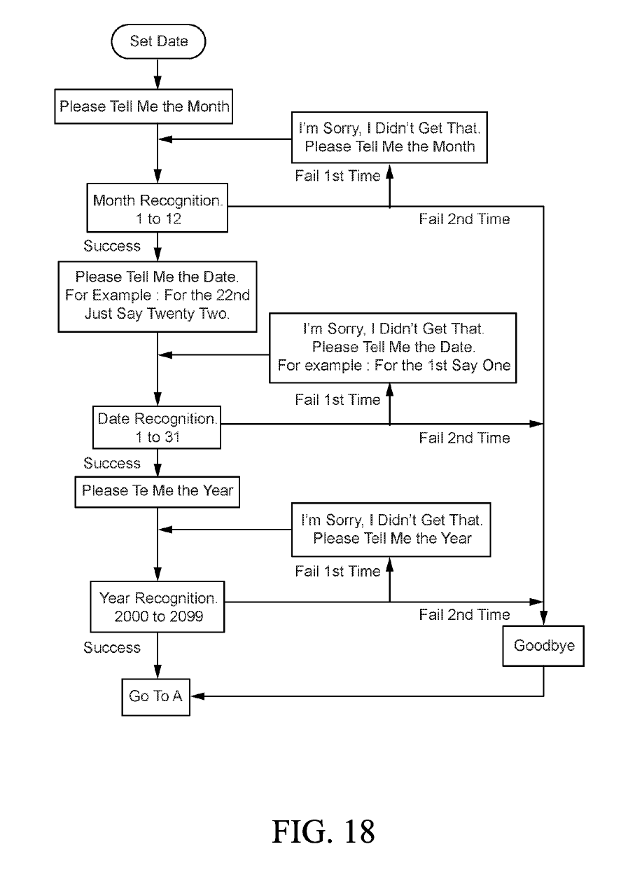

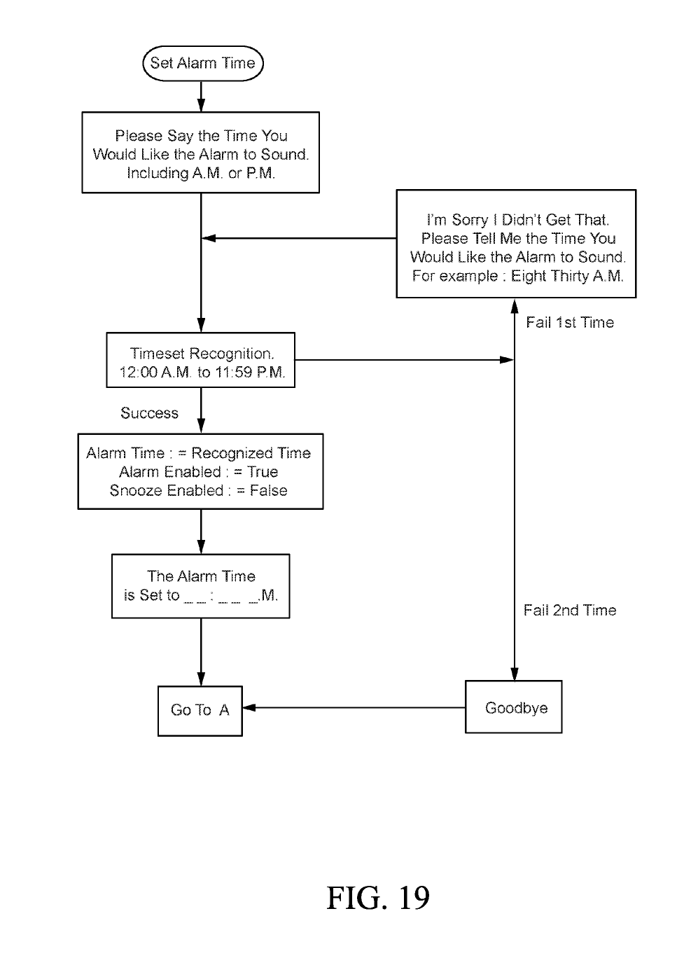

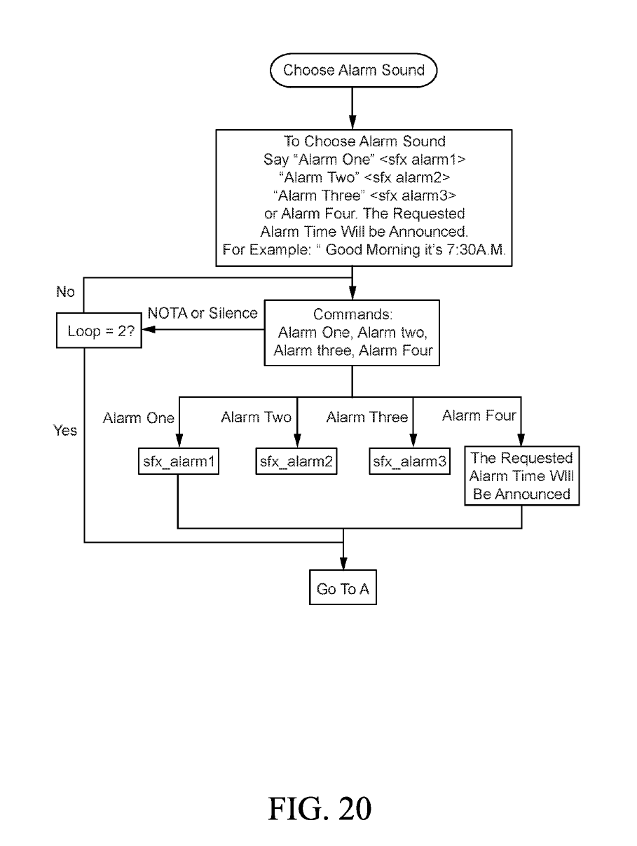

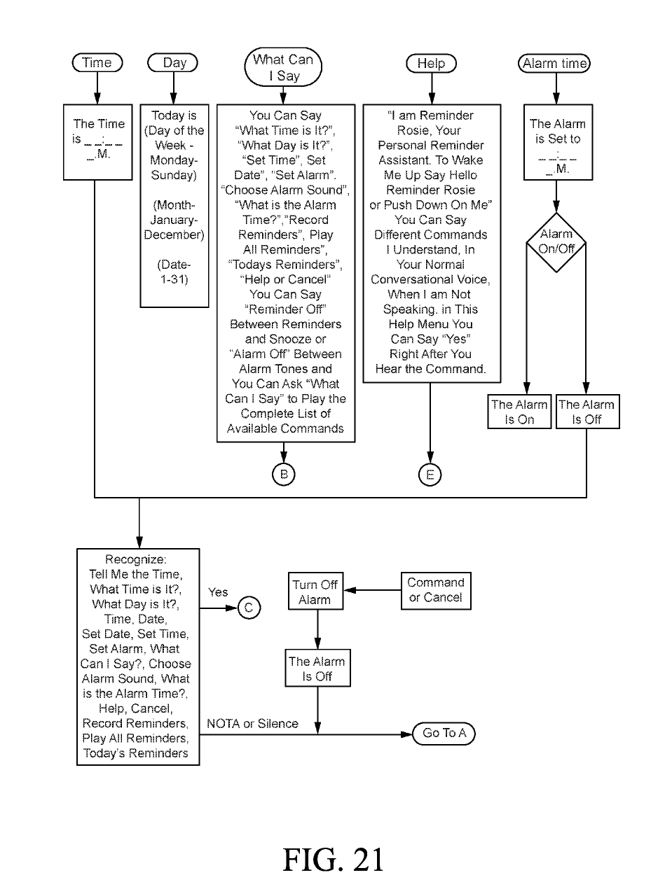

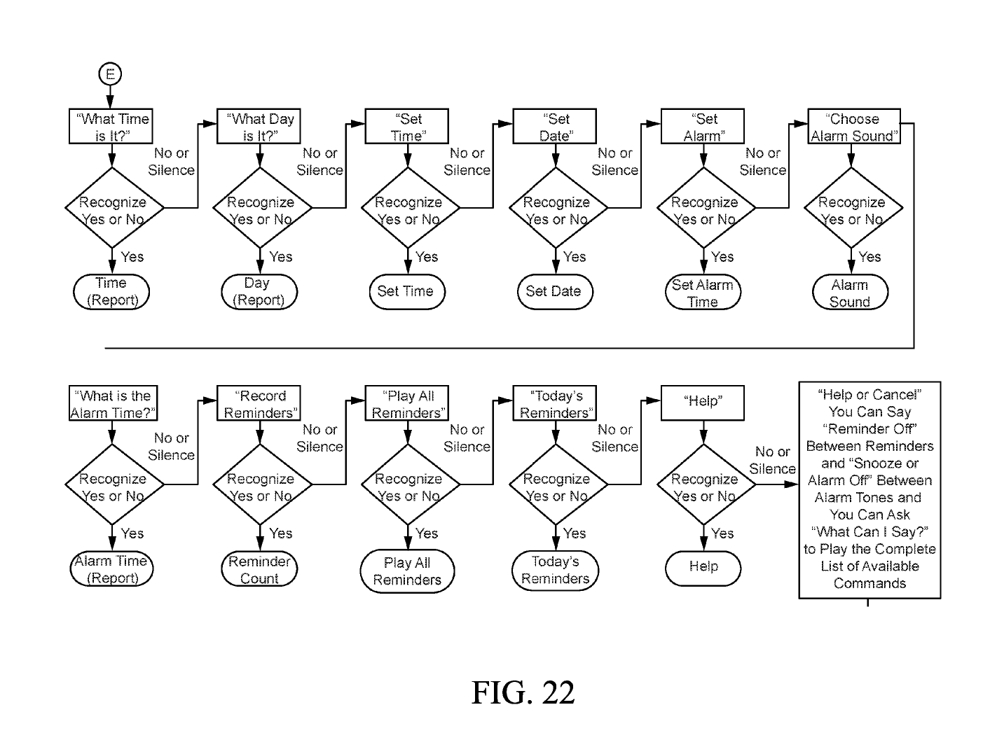

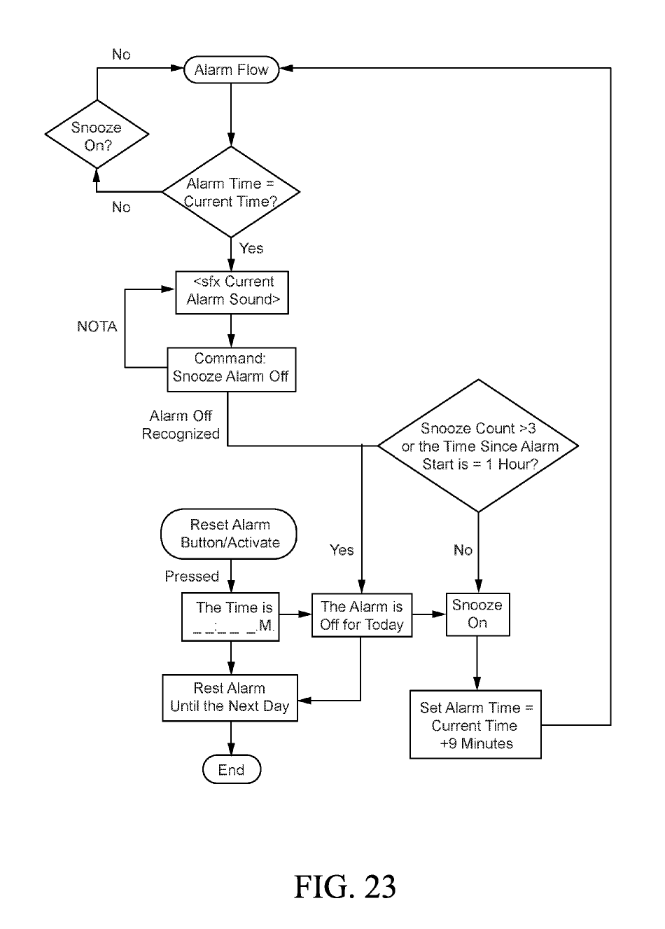

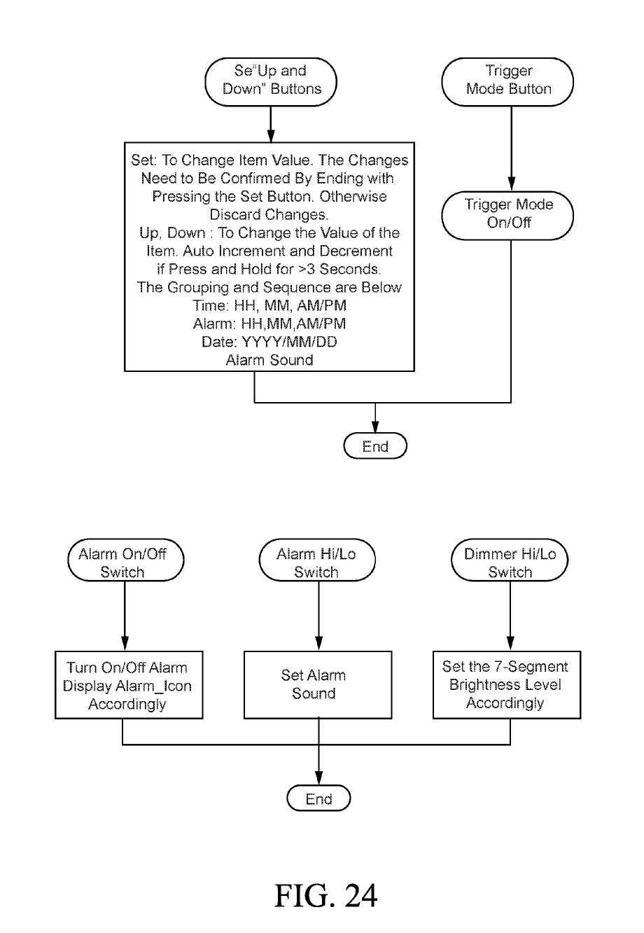

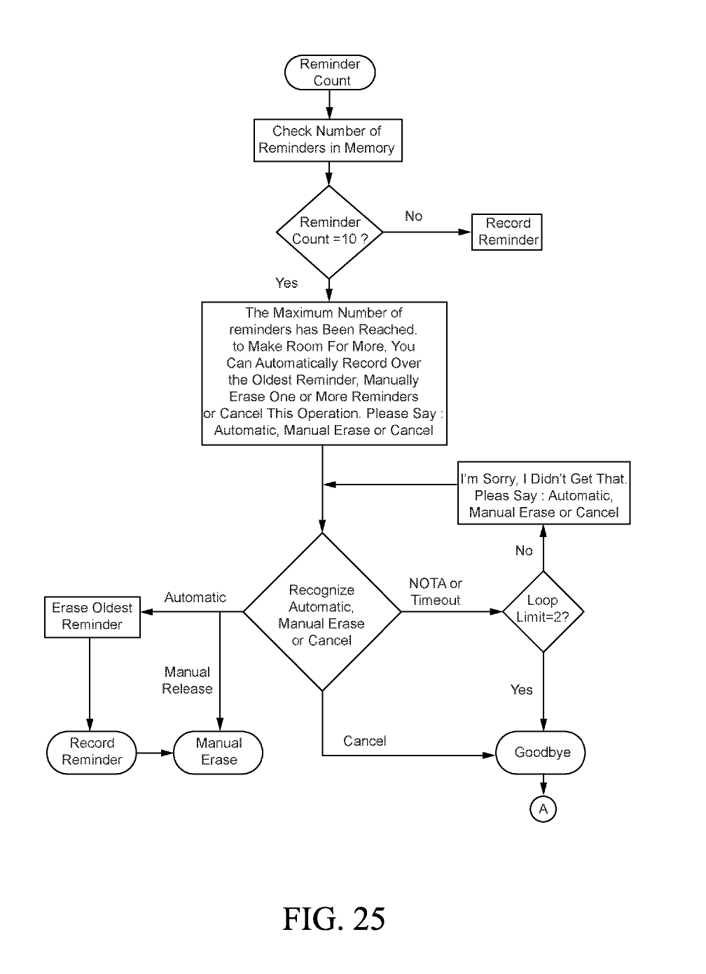

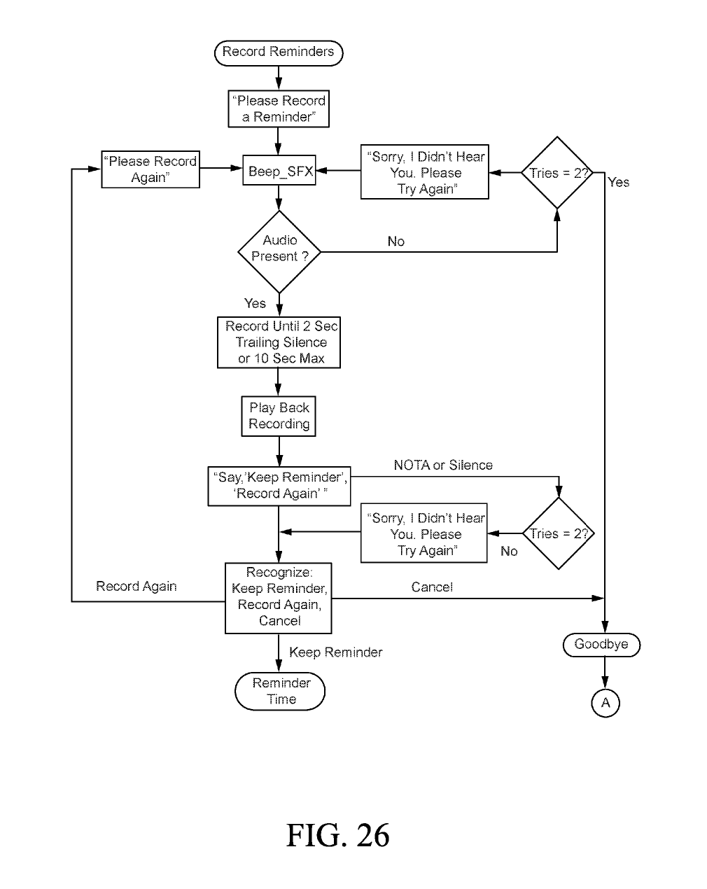

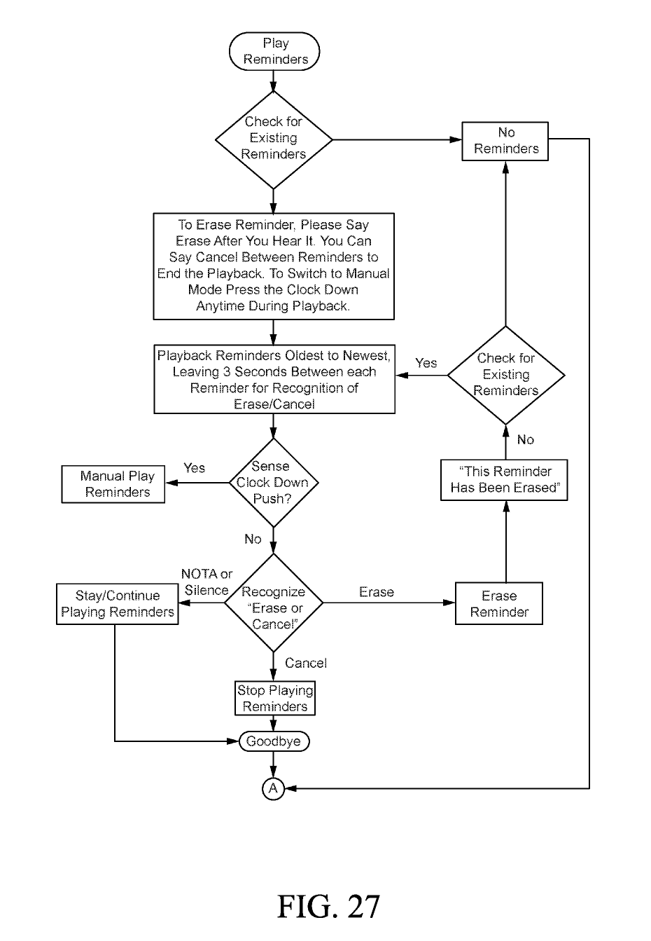

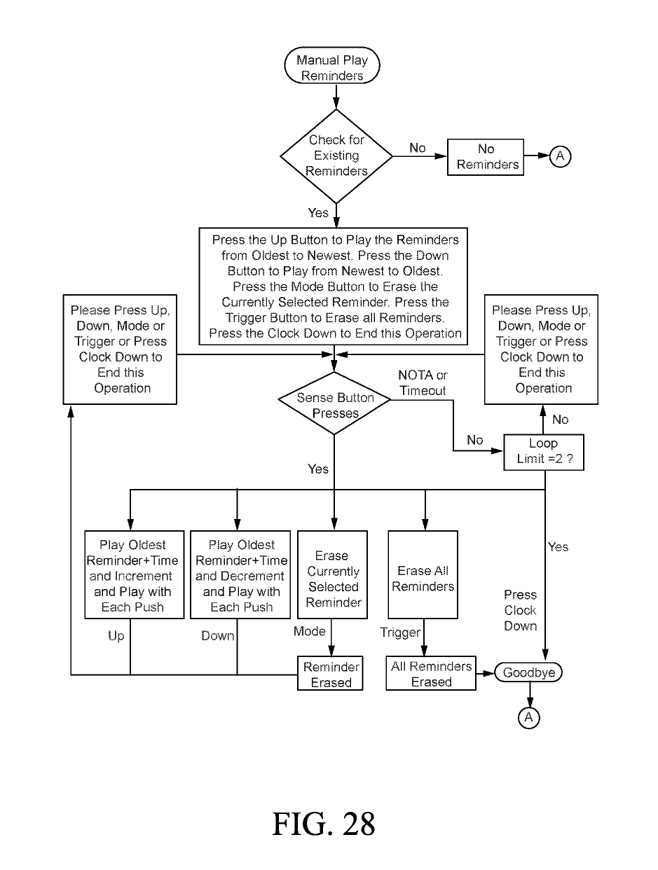

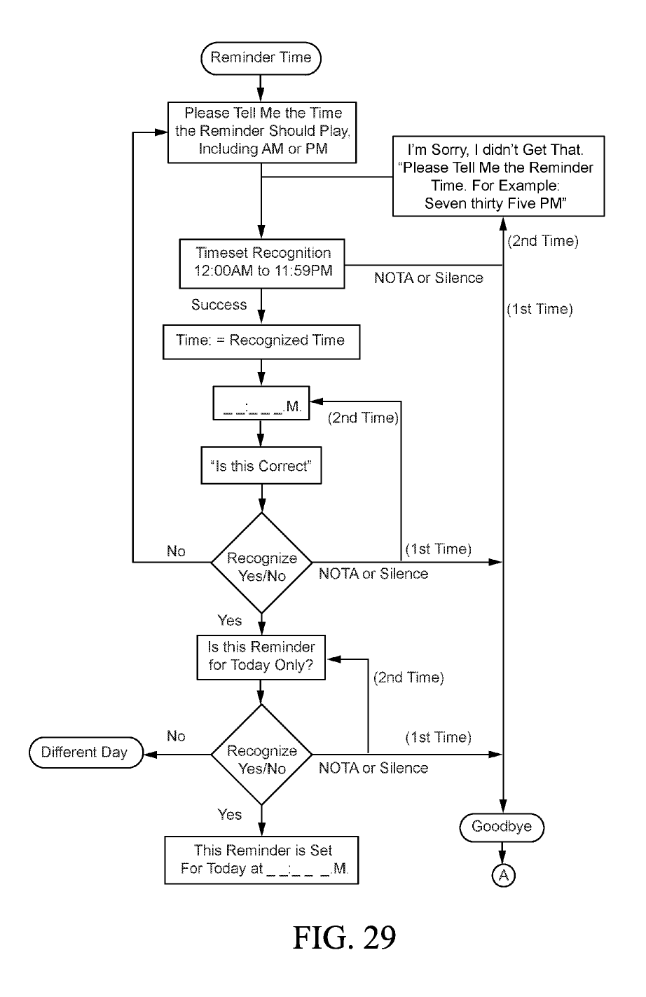

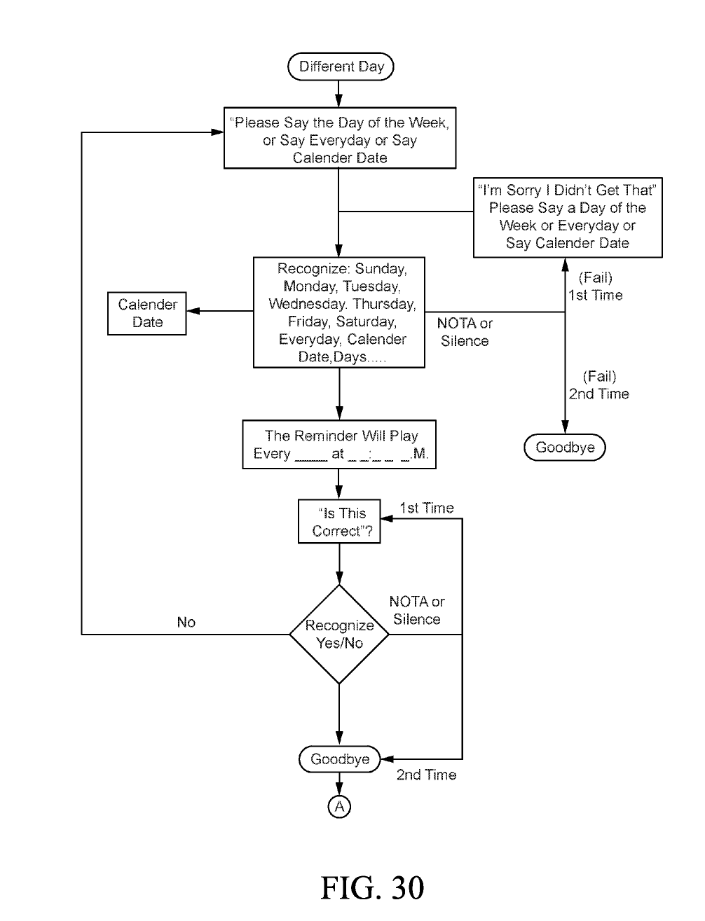

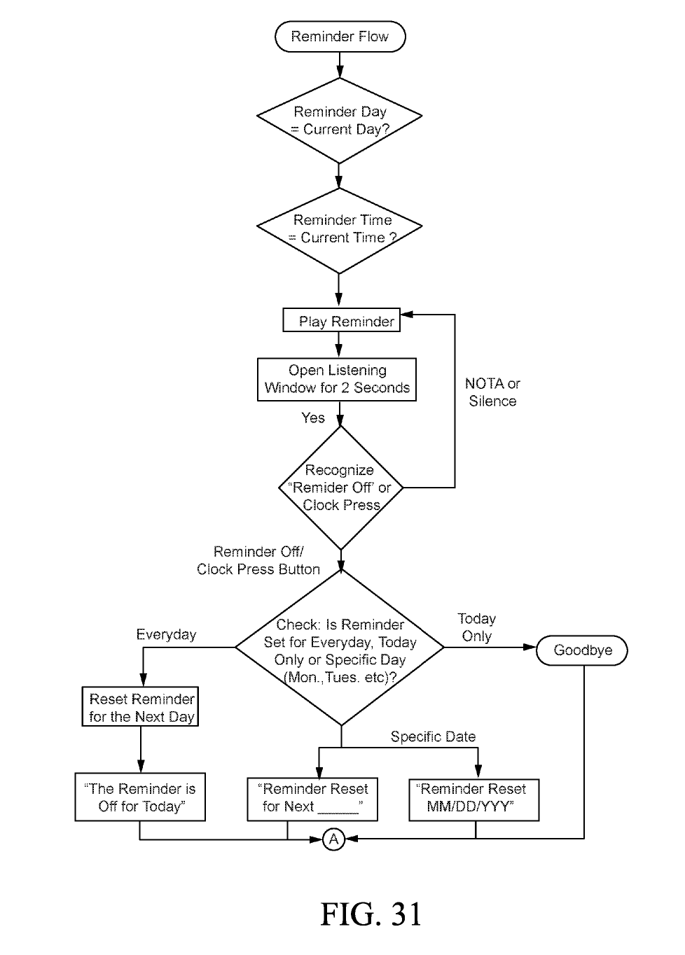

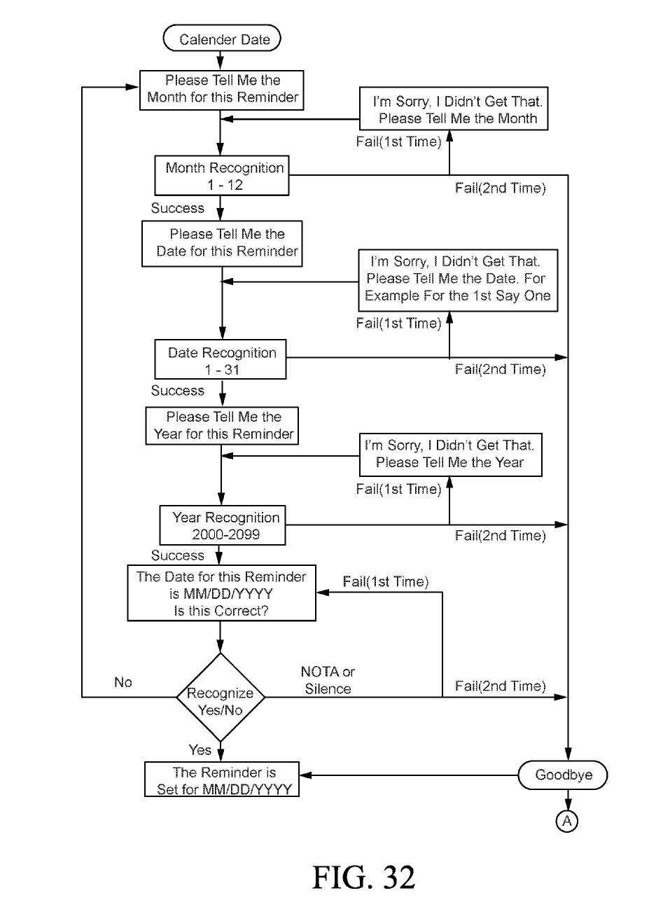

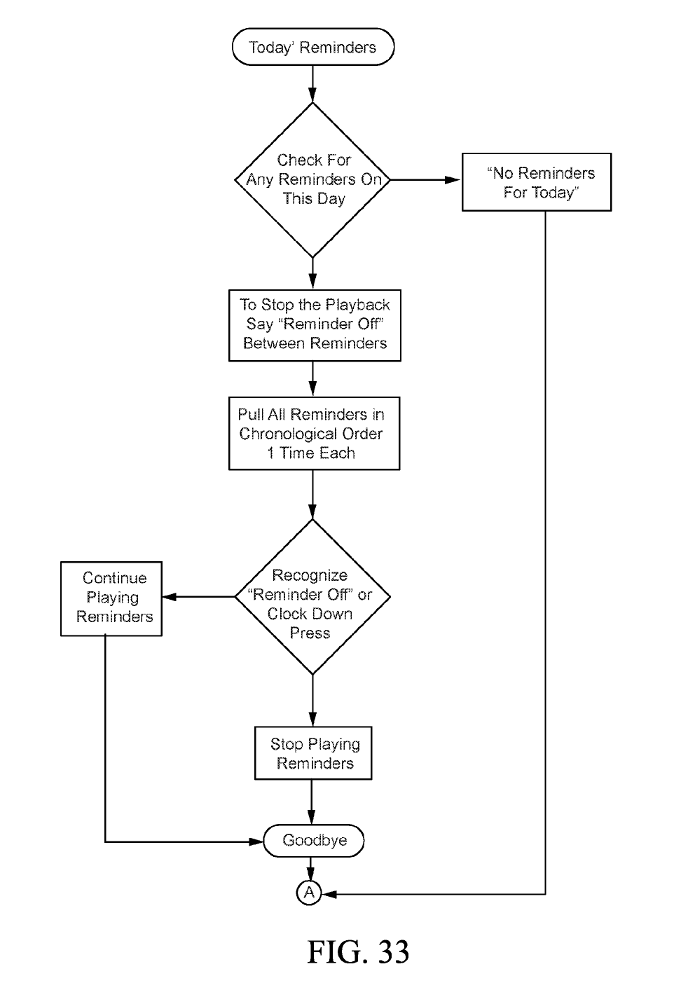

As can be seen in FIG. 1 through FIG. 33, the preferred embodiment of the present invention, the method for implementing a voice controlled notification system, is a method for implementing a virtual assistant that is capable of executing verbal commands and providing a local user with reminders about scheduled events and tasks. The method of the present invention is designed to be implemented by various electronic devices that include, but are not limited to, alarm clocks, smartphones, personal computers, tablets, and wearable devices. Furthermore, the method of the present invention enables the local user to set and disable notifications via verbal commands or by physically interacting with the electronic device that is being used to implement the method of the present invention. An additional functionality of the method of the present invention enables a remote user to set up a reminder notification that is relayed to the local user at an appropriate time. This enables the remote user to help the local user more effectively manage time and complete scheduled tasks. This functionality is augmented by the method of the present invention granting the local user an opportunity to acknowledge the completion of a scheduled task. In this way, the method of the present invention enables the remote user to be kept abreast of the local user's compliance when completing scheduled tasks.

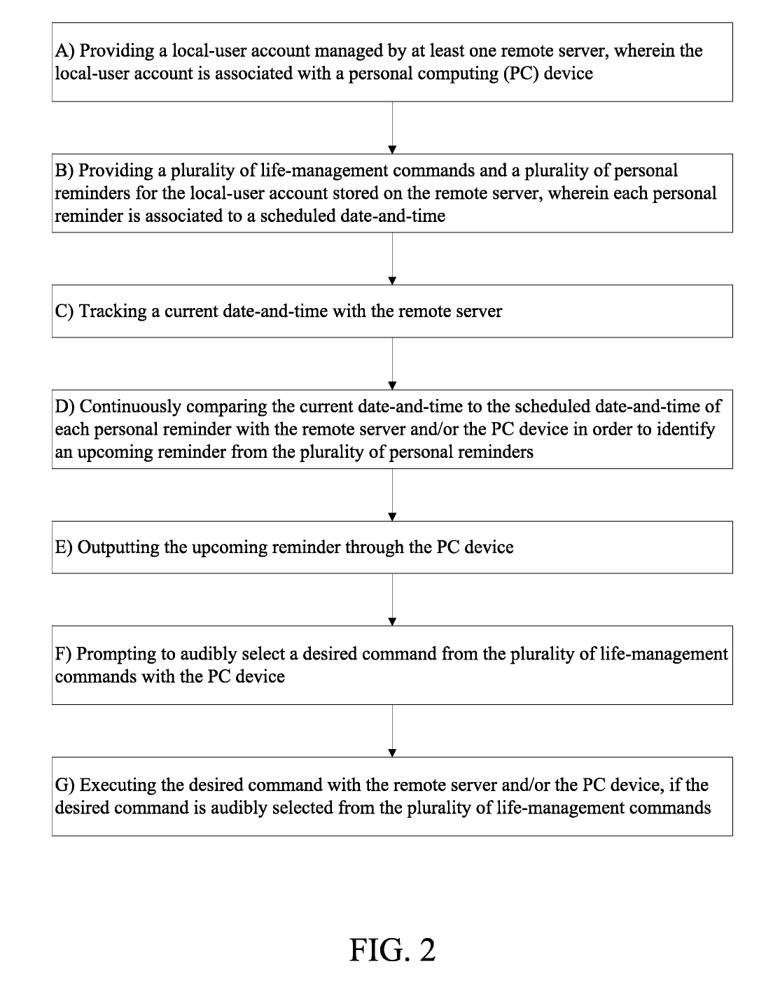

As can be seen in FIG. 1 and FIG. 2, to accomplish the above-described functionality, the method of the present invention makes use of a network of computing devices that are communicably coupled to store and manipulate information which relates to the local user. Specifically, the system required to implement the method of the present invention provides a local-user account managed by at least one remote server (Step A). The local-user account is a unique account that contains the local user's personal information, a collection of reminders and notifications, and any personal preferences the local user has specified. Additionally, the local-user account is associated with a personal computing (PC) device. The PC device is capable of communicating with the remote server, executing the method of the present invention, receiving user commands, and outputting reminder notifications. Furthermore, the system required to implement the method of the present invention provides a plurality of life-management commands and a plurality of personal reminders for the local-user account stored on the remote server (Step B). The plurality of life-management commands is a collection of predefined commands that the user can select from to execute a desired process. Additionally, the method of the present invention makes use of a vocal trigger that functions as an initialization phrase which must be spoken before the local user can issue verbal commands to the PC device. For example, the local user must first say a phrase such as “hey assistant” before verbally commanding the PC device to “list upcoming events for today”, this verbal command will be referenced against the plurality of life-management commands, and when the appropriate life-management command is identified, the PC device will output any personal reminders that are scheduled to occur before 11:59 pm. Accordingly, each of the personal reminders is a scheduled event or task for which the local user desires to receive a reminder notification. Additionally, each personal reminder is associated to a scheduled date-and-time. The scheduled date-and-time is the actual date and time at which the personal reminder will be relayed to the local user.

As can be seen in FIG. 1, the overall method of the present invention makes use of the above described system to enable the local user to manage multiple scheduling obligations and verbally control electronic devices. As such, the overall method of the present invention begins by tracking a current date-and-time with the remote server (Step C). This step enables the method of the present invention to maintain an accurate time and date. Embodiments of the present invention make use of real time clocks (RTC) to accurately report the current date-and-time. Additionally, the remote server is able to update the RTC using information gathered from various external time-reporting services. The overall method of the present invention continues by continuously comparing the current date-and-time to the scheduled date-and-time of each personal reminder with the remote server and/or the PC device in order to identify an upcoming reminder from the plurality of personal reminders (Step D). The upcoming reminder is the personal reminder that has a scheduled date-and-time which will occur at, or slightly after, the current date-and-time. Furthermore, the overall method of the present invention maintains a chronological listing of the plurality of personal reminders so that the PC device is able to notify the local user when a scheduled task or event is imminent. The overall method of the present invention continues by outputting the upcoming reminder through the PC device (Step E). Once the remote server identifies the upcoming reminder, the PC device alerts the local user. This alert can be audibly or visually output through the PC device. Additionally, the overall method of the present invention enables the local user to output the upcoming reminder through an external display device such as a TV, an alarm clock, a smartphone, or a computer screen.

As can be seen in FIG. 2, in addition to outputting upcoming reminders, the overall method of the present invention enables the local user to issue a verbal command to the PC device. Accordingly, the overall method of the present invention continues by prompting to audibly select a desired command from the plurality of life-management commands with the PC device (Step F). The desired command is any one of the plurality of life-management commands that the local user would like to have executed. This step enables the local user to say the desired command into the PC device. The PC device then receives and interprets the desired command. Specifically, local user is able to verbally command the PC device to accomplish tasks that include, but are not limited to, setting or reporting the date and time, setting an alarm, updating the personal reminders, adding new personal reminders, setting the sound for alarms, and searching for information on the internet. As such, the overall method of the present invention continues by executing the desired command with the remote server and/or the PC device, if the desired command is audibly selected from the plurality of life-management commands (Step G). Step G directs the overall method of the present invention to initiate various sub-processes which are directed toward executing the desired command. Additionally, the overall method of the present invention is designed to notify the local user if the desired command was not understood. For example, if the local user speaks an unintelligible command the PC device will output the message “I'm sorry I didn't understand you”. The overall method of the present invention then prompts the user to restate the desired command once more. If, after repeated attempts, the desired command is still not understood, the PC device will output the message “goodbye” and cease prompting the local user to restate the desired command.

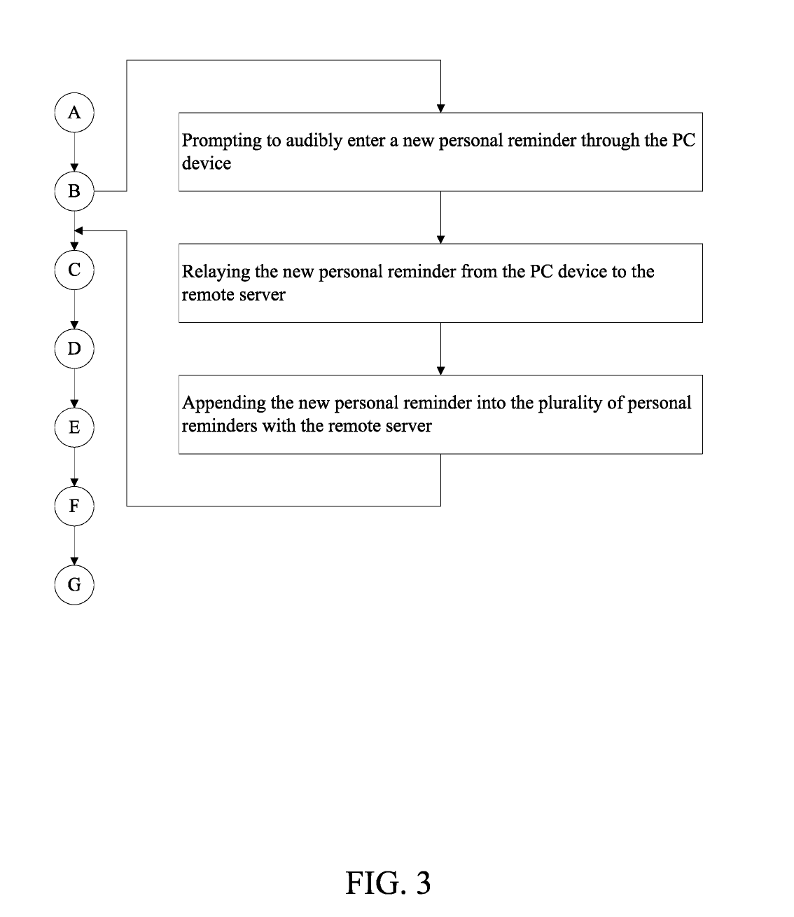

Referring to FIG. 3, as described above, the method of the present invention contains sub-processes that enables the local user to add new personal reminders to the plurality of personal reminders. As such, a sub-process that enables the local user to add personal reminders to the plurality of personal reminders begins by prompting to audibly enter a new personal reminder through the PC device. The sub-process is initiated when the local user says the vocal trigger and then commands the PC device to execute a “set new reminder” command. The local user is then able to record the new personal reminder by simply reciting a desired message. The sub-process continues by relaying the new personal reminder from the PC device to the remote server. And finally, the sub-process concludes by appending the new personal reminder into the plurality of personal reminders with the remote server. Accordingly, the recorded new personal reminder is transferred to the remote server and then added to the list of existing personal reminders.

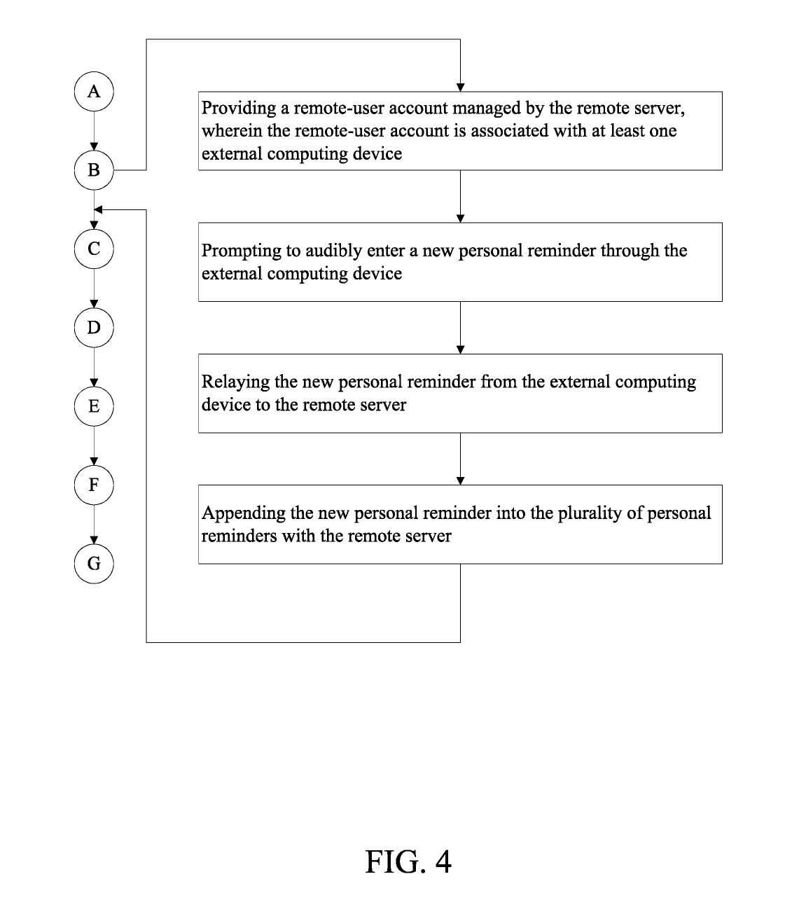

Referring to FIG. 4, as described above, the method of the present invention contains sub-processes that enables the remote user to add new personal reminders to the plurality of personal reminders. As such, the system required to implement this functionality provides a remote-user account managed by the remote server. The remote-user account is a unique account for the remote user and is stored on the remote server. Additionally, the remote-user account is associated with at least one external computing device. The external computing device is an electrical system that enables the remote user to interact with the method of the present invention. The sub-process continues by prompting to audibly enter a new personal reminder through the external computing device. This step enables the remote user to record a new personal reminder that will be presented to the local user at the appropriate time. The sub-process continues by relaying the new personal reminder from the external computing device to the remote server. Finally, the sub-process concludes by appending the new personal reminder into the plurality of personal reminders with the remote server. Accordingly, the recorded new personal reminder is transferred to the remote server and then added to the list of existing personal reminders.

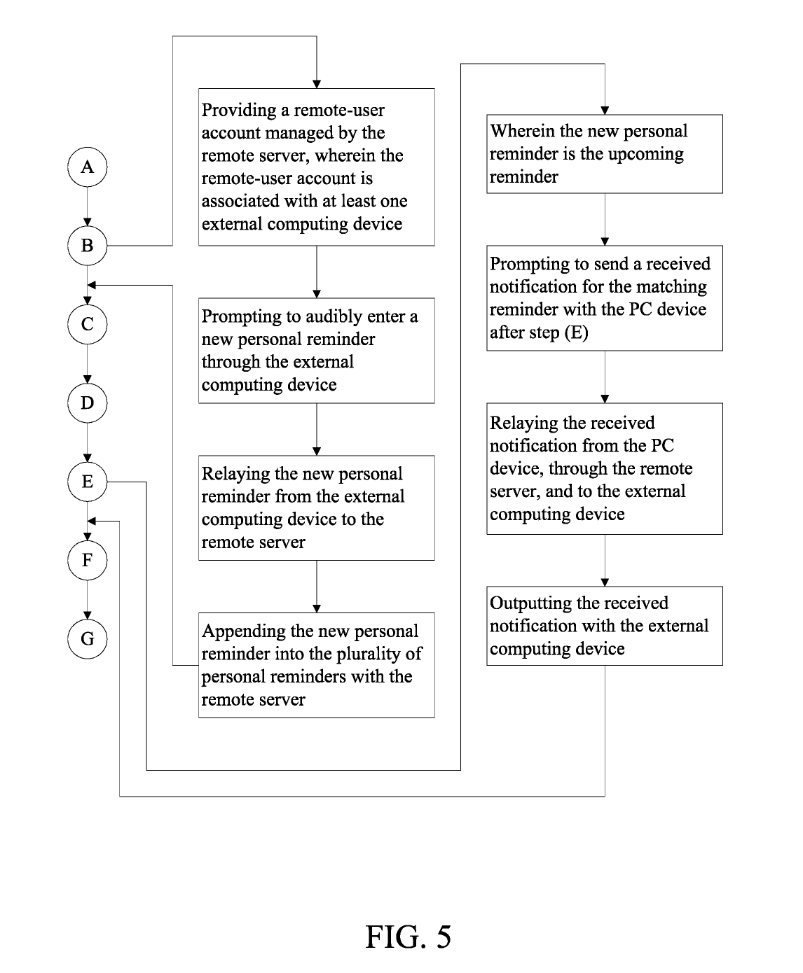

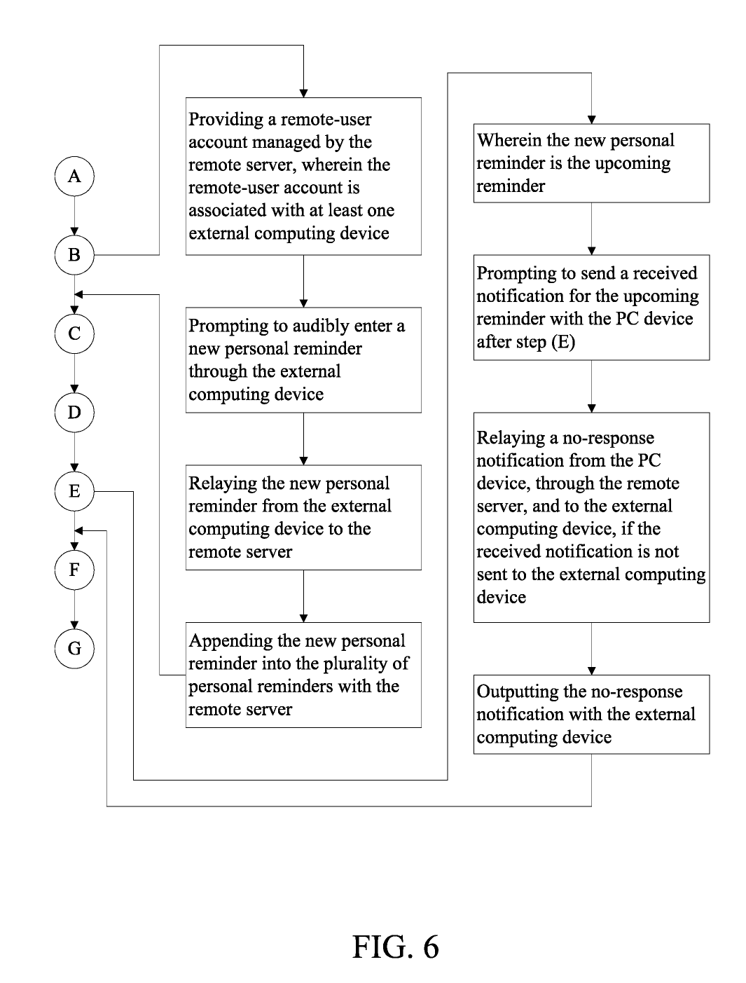

Referring to FIG. 5 and FIG. 6, the method of the present invention includes a sub-process that enables the remote user to receive an acknowledgement of receipt from the local user after relaying the new personal notification to the local user. This sub-process is initiated when the new personal reminder is the upcoming reminder. Specifically, the sub-process will require the local user to submit an acknowledgement of the personal notification that was created by the remote user when presented with the appropriate personal reminder. As such, the sub-process begins by prompting to send a received notification for the matching reminder with the PC device after Step E. The received notification contains the local user's acknowledgement of the personal notification that was created by the remote user. The local user is able to audibly acknowledge the personal notification was received and acted upon. Alternatively, the local user is able to press a button on the PC device to acknowledge that the personal notification was received and acted upon. The sub-process continues by relaying the received notification from the PC device, through the remote server, and to the external computing device. Finally, the sub-process concludes by outputting the received notification with the external computing device. Accordingly, the received notification is transferred to the remote user and then the remote user is notified that the local user has received and acted upon the personal notification. Conversely, the overall method of the present invention includes a sub-process for notifying the remote user that the local user did not acknowledge the receipt of the personal notification. This sub process begins by relaying a no-response notification from the PC device, through the remote server, and to the external computing device, if the received notification is not sent to the external computing device. The no-response notification is automatically generated by the PC device if the local user does not send the received notification within a given time period. The sub-process concludes by outputting the no-response notification with the external computing device. Accordingly, the no-response notification is presented to the local user, who may act accordingly.

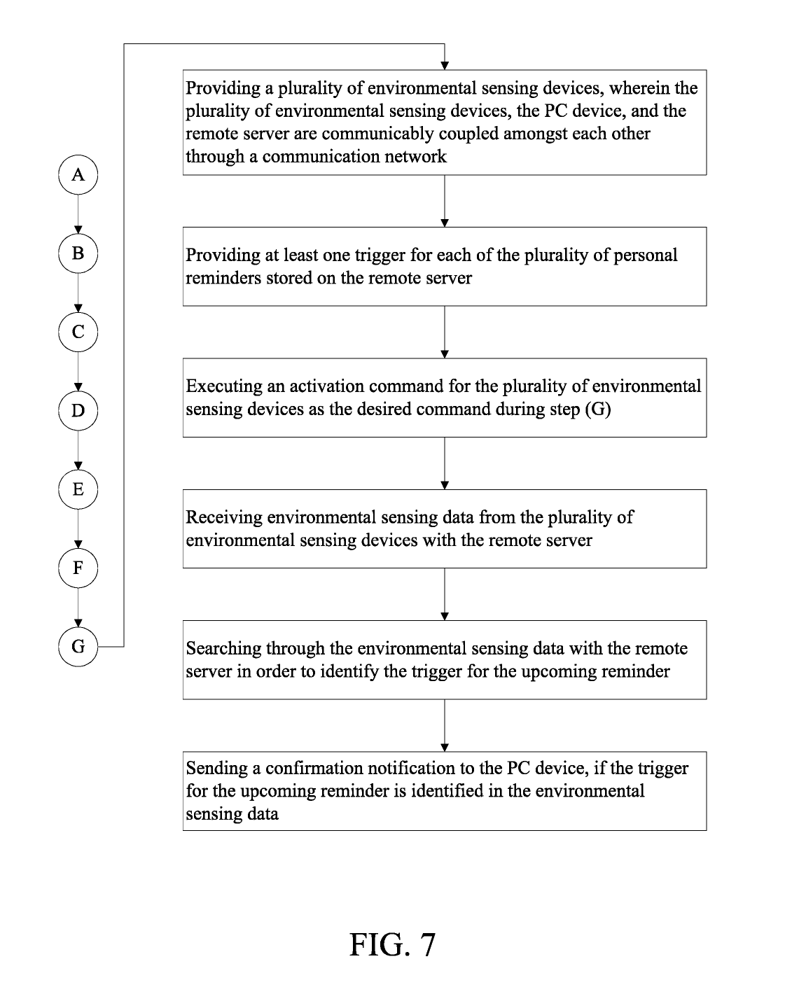

As can be seen in FIG. 7, the method of the present invention includes sub-processes for controlling multiple sensors and electronic devices. As such, the system required to implement the method of the present invention provides a plurality of environmental sensing devices. The plurality of environmental sensing devices comprises various electronic devices that include, but are not limited to, motion detectors, cameras, and temperature sensors. Additionally, the plurality of environmental sensing devices, the PC device, and the remote server are communicably coupled amongst each other through a communication network. As a result, the PC device and the remote server are able to issue commands to activate or deactivate any of the plurality of environmental sensing devices. Furthermore, the PC device and the remote server are able to receive and analyze the data that is produced by the plurality of environmental sensing devices. Moreover, the method of the present invention provides at least one trigger for each of the plurality of personal reminders stored on the remote server. Specifically, the sub-process for controlling the plurality of environmental sensing devices is designed to generate notifications in response to environmental triggers that are detected by the plurality of environmental sensors. For example, one of the plurality of environmental sensor devices may be a motion detector that is placed by the local user's bed. In this example, the local user is directed to get into bed at a specific time. Accordingly, the remote server will generate a notification if the motion detector determines that the local user has left bed after the specified time. The sub-process begins by executing an activation command for the plurality of environmental sensing devices as the desired command during Step G. The activation command is a command in which the local user specifies the environmental sensing device or devices that should be activated and thus initializes the trigger-detecting functionality for the environmental sensing device. Additionally, this step enables the local user to activate or deactivate any of the plurality of environmental sensing devices. The sub-process continues by receiving environmental sensing data from the plurality of environmental sensing devices with the remote server. The environmental sensing data is the data that is generated by the plurality of environmental sensing devices. Consequently, once the plurality of environmental sensing devices is activated, the environmental sensing data that is generated is transmitted to the remote server for analysis. The sub-process continues by searching through the environmental sensing data with the remote server in order to identify the trigger for the upcoming reminder. In this step, the remote server analyzes the environmental sensing data to determine if the trigger for any of the plurality of personal reminders has been detected. The sub-process concludes by sending a confirmation notification to the PC device, if the trigger for the upcoming reminder is identified in the environmental sensing data. The confirmation notification is a message that alerts the local user of the triggered personal notification. While the plurality of environmental sensing devices can be used to track the local user's movements, it is also for the plurality of environmental sensing devices to notify the local user of changes in the local user's environment. For example, the plurality of environmental sensing devices may contain a temperature sensor that alerts the user of a fire.

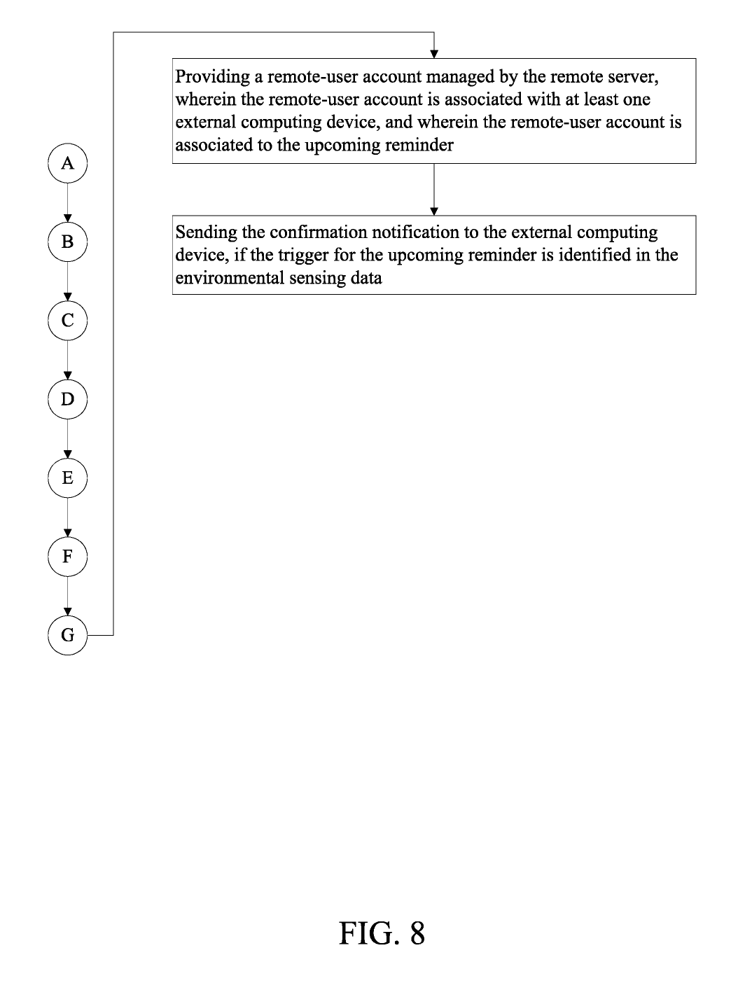

As can be seen in FIG. 8, in a related sub-process, the method of the present invention sends notifications to the remote user once the plurality of environmental sensing devices identifies a trigger. To accomplish this, the remote-user account is associated to the upcoming reminder. Accordingly, the sub process sends the confirmation notification to the external computing device, if the trigger for the upcoming reminder is identified in the environmental sensing data. As a result, the remote user is kept abreast of the local user's actions as well as changes in the environment around the local user. Alternatively, the remote user can set triggers for personal reminders so that the remote user is notified of changes in the local user's environment.

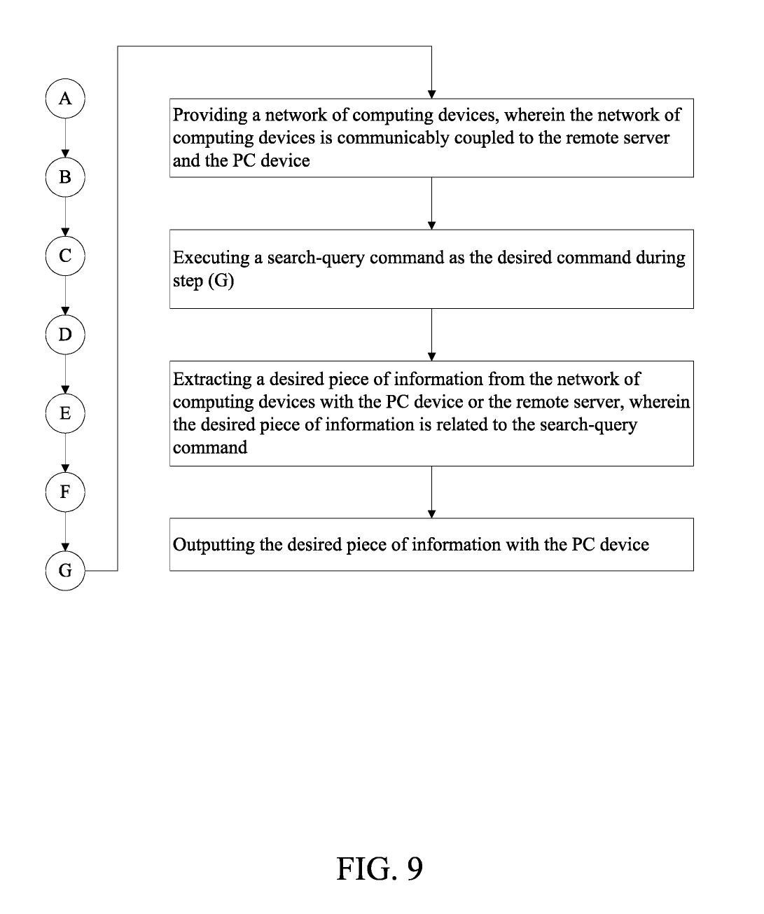

As can be seen in FIG. 9, the method of the present invention includes a sub-process that enables the local user to speak general queries to the PC device and receive relevant responses that are gathered from the internet and various external sources. To accomplish this, the system required to implement the method of the present invention provides a network of computing devices, wherein the network of computing devices is communicably coupled to the remote server and the PC device. The network of computing devices serves as the source from which the remote server seeks answers to the user's general queries. The sub-process begins by executing a search-query command as the desired command during Step G. The search-query command is one of the life-management commands that the local user selects to find the answer to a general query. For example, if the local user would like to know the weather, simply stating the vocal trigger and then saying, “what is the weather today” will initialize the search-query command sub-process. The sub-process continues by extracting a desired piece of information from the network of computing devices with the PC device or the remote server. The desired piece of information is the data that can be used to appropriately respond to the local user's general query. In this step, the remote server searches through the information that is available on the network of computing devices to identify the correct answer to the local user's general query. The sub-process concludes by outputting the desired piece of information with the PC device. Accordingly, the local user is presented with an accurate response to the spoken general query. The desired piece of information may be audibly or visually output by the PC device. Alternatively, the local user may display the desired piece of information on an external device such as an alarm clock, a TV, or a nearby computer.

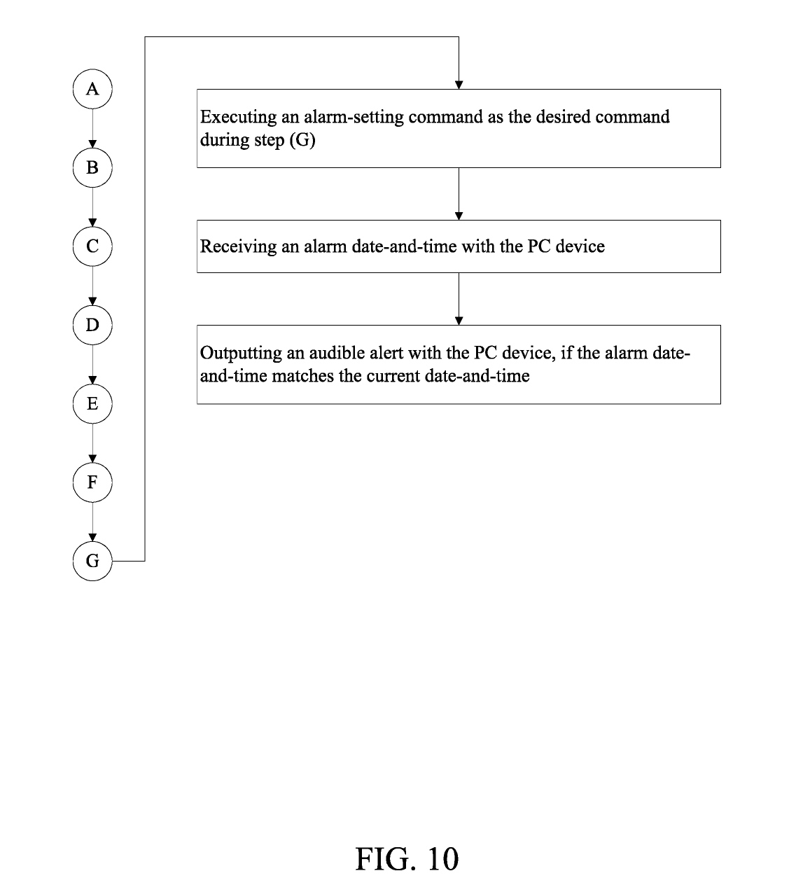

As can be seen in FIG. 10, the method of the present invention includes a sub-process that enables the local user to set alarms by issuing a verbal command. This sub-process is initiated by executing an alarm-setting command as the desired command during Step G. The alarm-setting command is selected from the plurality of life-management commands. The sub-process begins by receiving an alarm date-and-time with the PC device. Once the local user has spoken the alarm-setting command, the sub-process begins listening for the alarm date-and-time. The alarm date-and-time is the specified time at which the local user would like to set the alarm. Once the alarm date-and-time have been received, the sub-process concludes by outputting an audible alert with the PC device, if the alarm date-and-time matches the current date-and-time. Accordingly, the local user is alerted when the previously defined alarm date-and-time time arrives.

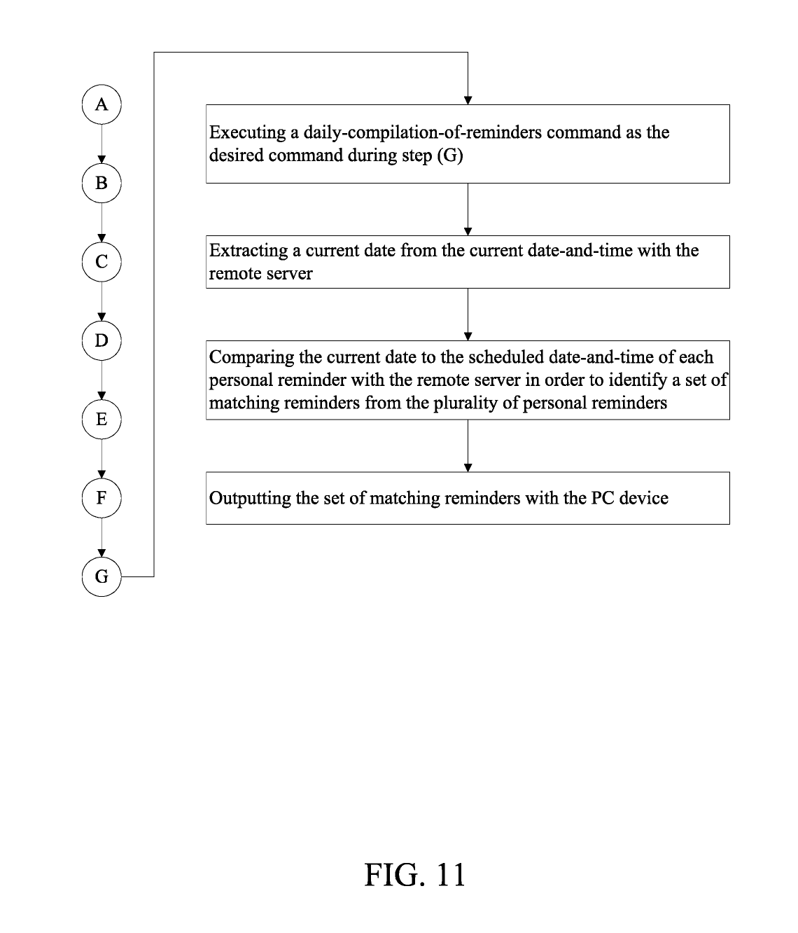

As can be seen in FIG. 11, the method of the present invention includes a sub-process that informs the local user of all reminders that are scheduled on a particular day. This sub-process is initiated by executing a daily-compilation-of-reminders command as the desired command during Step G. The daily-compilation-of-reminders command is selected from the plurality of life-management commands. The sub-process begins by extracting a current date from the current date-and-time with the remote server. Once the daily-compilation-of-reminders command is received, the remote server determines the current date and uses this as a criterion for filtering through the plurality of personal notifications. The sub-process continues by comparing the current date to the scheduled date-and-time of each personal reminder with the remote server in order to identify a set of matching reminders from the plurality of personal reminders. The set of matching reminders is a list of all the personal reminders that are scheduled for the current date. Finally, the sub-process concludes by outputting the set of matching reminders with the PC device. Accordingly, the local user is presented with a list of the personal reminders that are scheduled for the current date.

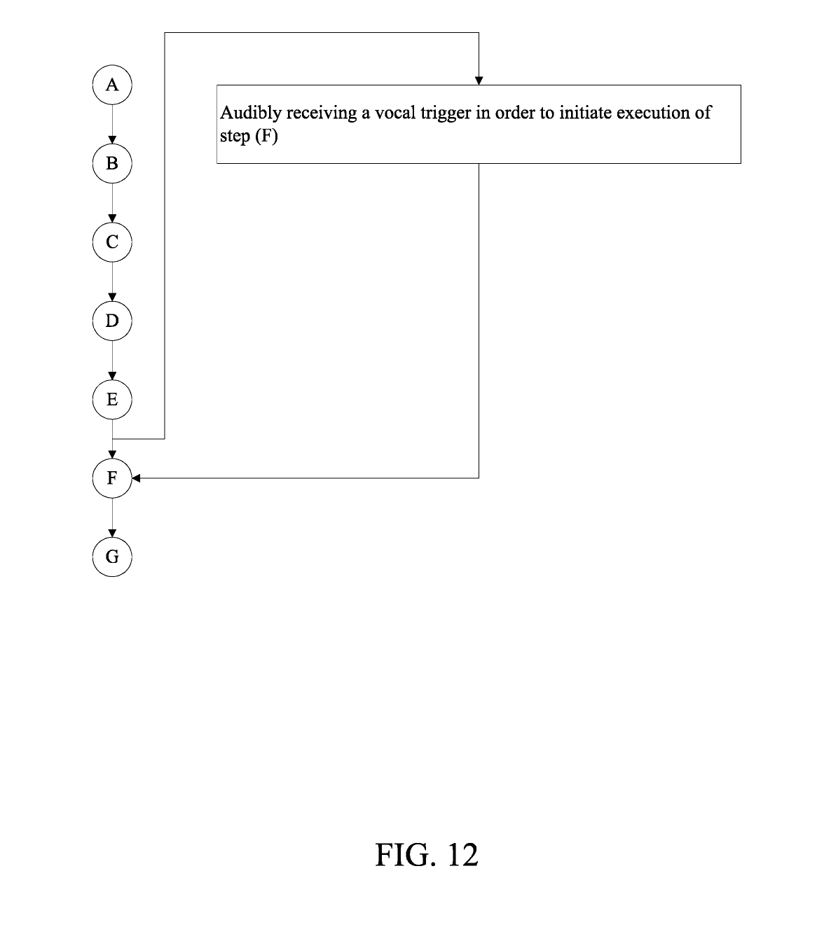

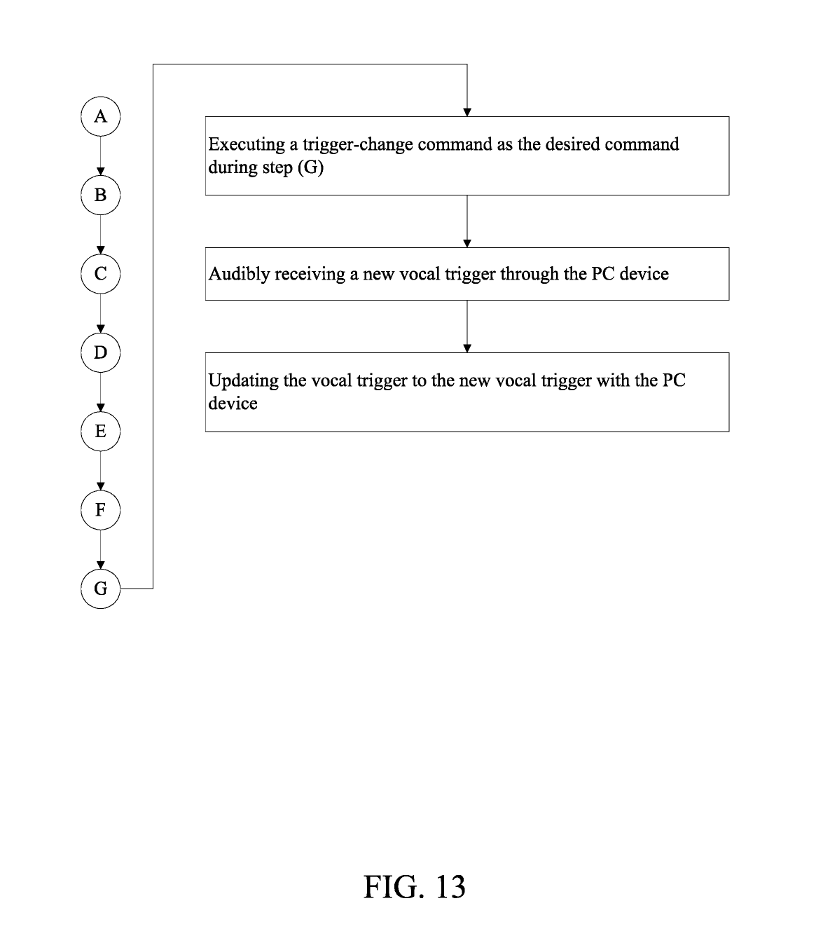

Referring to FIG. 12 and FIG. 13, as described above, the present invention makes use of a vocal trigger to initiate the desired command sub-processes. As such, the method of the present invention includes a sub-process that is dedicated to audibly receiving a vocal trigger in order to initiate execution of Step F. Additionally, the method of the present invention includes a sub-process that enables the local user to change the vocal trigger as desired. This sub-process is initiated by executing a trigger-change command as the desired command during Step G. the trigger-change command is selected from the plurality of life-management commands. The sub-process begins by audibly receiving a new vocal trigger through the PC device. To accomplish this step, the local user simply states the new vocal trigger that will be used to initiate future verbal command processes. The sub-process concludes by updating the vocal trigger to the new vocal trigger with the PC device. Accordingly, the local user must now speak the new vocal trigger before issuing any verbal commands to the PC device.

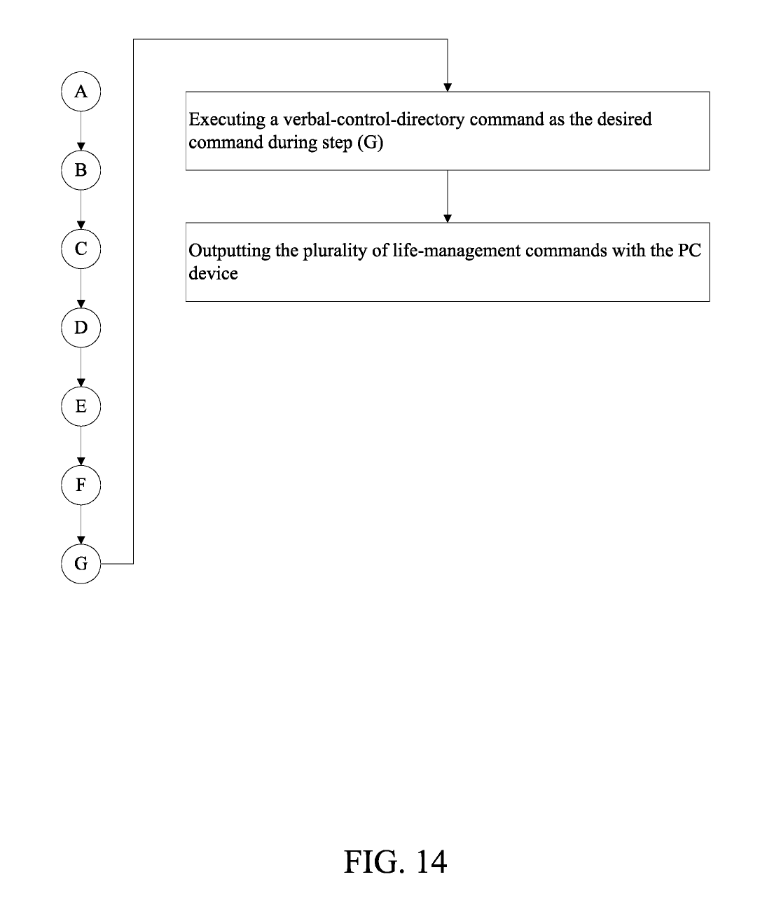

As can be seen in FIG. 14, the method of the present invention includes a sub-process that outputs the list of all possible verbal commands that the local user can issue to the PC device. This sub-process is initiated by executing a verbal-control-directory command as the desired command during Step G. The verbal-control-directory command is selected from the plurality of life-management commands. The sub-process concludes by outputting the plurality of life-management commands with the PC device. Accordingly, the local user is presented with a list of all the possible verbal commands that can be issued to the PC device.

Although the invention has been explained in relation to its preferred embodiment, it is to be understood that many other possible modifications and variations can be made without departing from the spirit and scope of the invention as hereinafter claimed.

### SUPPLEMENTARY DESCRIPTIONS OF THE INVENTION

In one aspect, the device can structurally look like a traditional or modern digital clock, or it could be a part of any device with a display (a microwave or electronic fridge, or a PC or tablet), or any electronic timepiece or wrist wear or wearable on any part of your body. The device with the reminder system capability can be either powered by an AC outlet or a battery as a mobile device, such as a cell phone. The device can also be connected to a network in your home or work, either wirelessly via its internal wireless interface (Wi-Fi, or a 4G LTE modem or blue tooth) or similar data transfer technology, or via a direct wire network connection (RJ-45), so reminders can be set and or monitored via a networked computer, tablet, or an appropriate cell phone from any location worldwide.

The device will store several audio alarm messages which are spoken into the device and or remotely entered into the device's non-volatile memory, for playback at specific times and dates, over several years as required.

The device will include an “acknowledgement” feature, meaning a manual switch (on the device or via a wireless fob/pendant type device) and or via a voice commanded alarm shutoff, then can alert a caregiver (family member or professional) that the reminder has been or has not been acknowledged by the user.

In one aspect, the device may have pillboxes or containers which hold medications or any small item(s), attached or as part of the device which helps to remind the user/patents to take their medications or for the user to take an action related to that item.

The Reminder device, when connected to a network which has access to the internet, either through a home or office network or via a mobile radio/telephone network, will also have the ability to, when asked verbally a specific question to receive a verbalized reply, or display on its display screen or any attached monitor/TV display screen, important information such as weather alerts/conditions, sports scores, stock quotes, traffic conditions or newsworthy stories or public emergencies either local or worldwide, or on any topic the user requests (if available).

In one aspect, the device will (if equipped) be able to indicate if it has detected that the user has moved in or around the area monitored around the device, i.e. if the motion sensor is placed near the user's bed it can signal the device which delivers a message to a remote person that the user has gotten in and or out of bed or not within the programmed time intervals, allowing the remote person to take necessary action.

In one aspect, the device will be able to monitor any appropriate wireless alarm sensor(s) within range of the device and signal the system's status conditions, such as doors and windows are opened or that they are closed, stove is left on based on pre-set time intervals etc.

The reminder device functions will be able to be incorporated into any digital, LCD or LED and or similar display, wristwatches or any electronic timepiece. The reminder timepiece can be incorporated into any device imaginable, ranging from robotic vacuum cleaners to humidifier to mobile phones. Additionally, the system can be implemented on a computer, an appliance, or a mobile phone.

Any and all languages can be recognized and applied to any device in conjunction with a device that also has Wi-Fi or direct communication to mobile networks. The device can be attached integrated into pillboxes or any container of any shape and size.

In another aspect, the device will include an AM and or FM radio module that responds to timing and/or alarm functions of the system's time clock scheduler routine. For example, when commanded by voice commands, the device will turn the radio on or off at a specified time.

The reminder device provides information and instructions to the user as spoken phrases or command instructions via the enclosed audio speaker and on various displays such as on its internal Clock or color LCD display screen, and on various external TV monitors/display/screens and their speakers. These external systems display the requested information, such as the date and time, and any other requested information etc. to the user.

The Reminder device is based upon one or more microprocessors within each device, which control the recording and play back of audio messages, the detection of spoken commands, the monitoring of buttons/switches/sensors, the time clock scheduler which generates the alarm events, the annunciating of the time of day, the uploading of the devices memory/status to the network/users and the when to turn on and off the various external devices under the devices controls etc.

The device is a complex micro-processor based apparatus, which may be built in various ways. Depending on the components selected, the number of parts will vary, so as to best illustrate the device's required functionality, they are shown as discrete components in the figures, however a device could be potentially built using one or more parts that could include up to seven of the required functional elements. The items enclosed inside the dashed outline. The actual parts selected is not material to the design.

A microphone senses the audio, the audio processor digitizes, and its speech recognition routines decode the detected audio phrases and or commands and sends them on to the. The main processor executes instructions. The audio processor is programmed to recognize and associate user-chosen audio commands and instructions with specific time and date alarm functions. For example, the alarm clock system may be programmed to activate an alarm function in response to the command “Turn alarm on” or in response to programmed message which is to be delivered at a programmed time on a specific day. In another example, the device is designed to deliver the message “Dad take four white pills and one blue pill with a glass of water” using the audio processor. The audio processor is preferably a digital to analog (D/A) converter. The device then outputs the message via the speaker every day at 9:30 AM etc.

To keep the time base very accurate the Main processor employs a real-time clock (RTC) which always runs even when the unit is running off the internal standby battery pack. Within the sensor & RTC block are several electronic sensors, i.e. a temperature sensor for monitoring the room's ambient temperature, one or more passive infrared (IR) sensors for detecting the user's approach or detecting movement near or around the device's sensor or via other external sensors communicating to the device; a stove sensor, a door sensor, a water leak sensor, a carbon monoxide sensor. If reminders are not acknowledged by the user within a pre-set time frame, a message is sent to a remote person.

The audio prompts generated by the audio processor's D/A converter are sent to the internal speaker and to the optional external speaker(s). There are symbols & messages shown on the various displays on or connected to the Reminder device, to assist the user in its programming and the recording of voice commands, messages and instructions which are stored internally in non-volatile memory for use by the audio processor and the main processor of the reminder device.

The main processor maintains the time clock scheduler, which it synchronizes to the battery backed up RTC clock. When power is applied to the device by its DC in connector, the processors start checking for messages and alarms that should have been delivered during the battery backed-up interval, and immediately plays them to the user and awaits their acknowledgment.

When the device has access to the internet, it will at scheduled intervals adjust the RTC and the time clock scheduler to the internet's time clock. In this manner, the device's clocks will never be off by more than a few seconds in any day, i.e. until the next update cycle occurs.

The main processor also captures the video from the camera, and handles all the graphic display(s) functions, the networking communication routines, and the various remote-control functions.

A wireless transceiver and corresponding control firmware will be installed into the reminder device to permit the main processors alarm/clocking functions to control and the monitoring of all the external electronic devices/sensors, such as, a the wireless remote “Assistance/Panic” push button, a fridge, the various room Lights, television, a coffee machines and/or other types of devices etc. connected to its network.

In one aspect, when the device is connected to the web the main processor would capture video of the user from the camera, and using the graphic display(s), the Audio processor's audio capture [Microphone, A/D] & playback functions [D/A, Speaker], and “Skype” compatible software. Provide as means for health practitioners, family members, and caregivers to communicate with the User.

In one aspect, the device can be commanded to display stored pictures from its internal memory, or when it is connected to the web, by using the networking interfaces and related communication routines, it can downloaded images, so it functions as electronic picture album or as a message board and or as an internet TV.

What is claimed is:

1. A method for implementing a voice controlled notification system, the method comprises the steps of:
(A) providing a local-user account managed by at least one remote server, wherein the local-user account is associated with a personal computing (PC) device;
(B) providing a plurality of life-management commands and a plurality of personal reminders for the local-user account stored on the remote server, wherein each personal reminder is associated to a scheduled date-and-time;
(C) tracking a current date-and-time with the remote server;
(D) continuously comparing the current date-and-time to the scheduled date-and-time of each personal reminder with the remote server and/or the PC device in order to identify an upcoming reminder from the plurality of personal reminders;
(E) outputting the upcoming reminder through the PC device;
(F) prompting to audibly select a desired command from the plurality of life-management commands with the PC device;
(G) executing the desired command with the remote server and/or the PC device, if the desired command is audibly selected from the plurality of life-management commands;

2. The method for implementing a voice controlled notification system, the method as claimed in claim 1 comprises the steps of:
prompting to audibly enter a new personal reminder through the PC device;
relaying the new personal reminder from the PC device to the remote server;
appending the new personal reminder into the plurality of personal reminders with the remote server;

3. The method for implementing a voice controlled notification system, the method as claimed in claim 1 comprises the steps of:
providing a remote-user account managed by the remote server, wherein the remote-user account is associated with at least one external computing device;
prompting to audibly enter a new personal reminder through the external computing device;
relaying the new personal reminder from the external computing device to the remote server;
appending the new personal reminder into the plurality of personal reminders with the remote server;

4. The method for implementing a voice controlled notification system, the method as claimed in claim 3 comprises the steps of:
wherein the new personal reminder is the upcoming reminder;
prompting to send a received notification for the matching reminder with the PC device after step (E);
relaying the received notification from the PC device, through the remote server, and to the external computing device;
outputting the received notification with the external computing device;

5. The method for implementing a voice controlled notification system, the method as claimed in claim 3 comprises the steps of:
wherein the new personal reminder is the upcoming reminder;
prompting to send a received notification for the upcoming reminder with the PC device after step (E);
relaying a no-response notification from the PC device, through the remote server, and to the external computing device, if the received notification is not sent to the external computing device;
outputting the no-response notification with the external computing device;

6. The method for implementing a voice controlled notification system, the method as claimed in claim 1 comprises the steps of:
providing a plurality of environmental sensing devices, wherein the plurality of environmental sensing devices, the PC device, and the remote server are communicably coupled amongst each other through a communication network;
providing at least one trigger for each of the plurality of personal reminders stored on the remote server;
executing an activation command for the plurality of environmental sensing devices as the desired command during step (G);
receiving environmental sensing data from the plurality of environmental sensing devices with the remote server;
searching through the environmental sensing data with the remote server in order to identify the trigger for the upcoming reminder;
sending a confirmation notification to the PC device, if the trigger for the upcoming reminder is identified in the environmental sensing data;

7. The method for implementing a voice controlled notification system, the method as claimed in claim 6 comprises the steps of:
providing a remote-user account managed by the remote server, wherein the remote-user account is associated with at least one external computing device, and wherein the remote-user account is associated to the upcoming reminder;
sending the confirmation notification to the external computing device, if the trigger for the upcoming reminder is identified in the environmental sensing data;

8. The method for implementing a voice controlled notification system, the method as claimed in claim 1 comprises the steps of:
providing a network of computing devices, wherein the network of computing devices is communicably coupled to the remote server and the PC device;
executing a search-query command as the desired command during step (G);
extracting a desired piece of information from the network of computing devices with the PC device or the remote server, wherein the desired piece of information is related to the search-query command;
outputting the desired piece of information with the PC device;

9. The method for implementing a voice controlled notification system, the method as claimed in claim 1 comprises the steps of:
executing an alarm-setting command as the desired command during step (G);
receiving an alarm date-and-time with the PC device;
outputting an audible alert with the PC device, if the alarm date-and-time matches the current date-and-time;

10. The method for implementing a voice controlled notification system, the method as claimed in claim 1 comprises the steps of:
executing a daily-compilation-of-reminders command as the desired command during step (G);
extracting a current date from the current date-and-time with the remote server;
comparing the current date to the scheduled date-and-time of each personal reminder with the remote server in order to identify a set of matching reminders from the plurality of personal reminders;
outputting the set of matching reminders with the PC device;

11. The method for implementing a voice controlled notification system, the method as claimed in claim 1 comprises the steps of:
audibly receiving a vocal trigger in order to initiate execution of step (F);

12. The method for implementing a voice controlled notification system, the method as claimed in claim 11 comprises the steps of:
executing a trigger-change command as the desired command during step (G);
audibly receiving a new vocal trigger through the PC device;
updating the vocal trigger to the new vocal trigger with the PC device;

13. The method for implementing a voice controlled notification system, the method as claimed in claim 1 comprises the steps of:
executing a verbal-control-directory command as the desired command during step (G);
outputting the plurality of life-management commands with the PC device;
